(19) United States
(12) Patent Application Publication
(10) Pub. No.: US 2013/0110166 A1
(43) Pub. Date: May 2, 2013

(54) Pacifier retaining device

(71) Applicant: Melissa Sugarman Slayen, Ross, CA (US)

(72) Inventor: Melissa Sugarman Slayen, Ross, CA (US)

(21) Appl. No.: 13/317,842

(22) Filed: Oct. 31, 2011

(51) Int. Cl. A61J 17/00

(52) U.S. Cl. 606/234

(57) ABSTRACT

A pacifier retaining device with a resilient partial ring shaped member, a rigid nipple storage enclosure and a necklace connection member. The resilient ring has an approximate C shape where the gap in the C shape is approximately one quarter of an inch. The nipple storage enclosure is cylindrical in shape and having a closed top and an open bottom. The rigid nipple storage enclosure is attached from its top surface to the the inside surface of the resilient partial ring at the inside surface of the ring shaped opposite to the gap in the C shape. The necklace connection member is attached to to outside surface of the ring directly above the nipple storage enclosure connection point. A preferred embodiment includes the end points of the C shaped partial ring include outwardly disposed lead in tabs.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of infant care accessories and more specifically to a pacifier retaining device.

The use of pacifiers is wide spread around the world. A pacifier is a device that includes a rubbery nipple portion attached a mouth guard portion. They are put in an infants mouth by a parent or a care giver and generally produce a calming effect for the infant. The nipple portion of the pacifier has a tendency to become soiled when the pacifier is put away in a pocket or purse after use. To solve this problem, it is helpful to provide some sort of pacifier cover. Various pacifier covers have been designed and patented. These include protective covers such as the one shown in U.S. Pat. No. 4,329,996 and U.S. Pat. No. 4,946,054. These covers are designed to be attached to specific shaped pacifiers having specific shaped mouth guards. Additionally, containers have been designed for the specific purpose of housing pacifiers, including the one found in U.S. Pat. No. 5,485,505. However, there is a deficiency in the prior art in that none of the prior pacifier covers are designed to removably retain a wide variety of standard pacifiers having a variety of nipple shapes and a variety of mouth guard shapes.

### BRIEF SUMMARY OF THE INVENTION

The primary object of the invention is to provide a pacifier retaining device that allows a person to easily retain and remove any standard pacifier from a holder that can be conveniently carried by a user.

Another object of the invention is to provide a pacifier retaining device that can be worn in conjunction with a necklace.

Another object of the invention is to provide a pacifier retaining device that is easy and economical to manufacture.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a pacifier retaining device comprising: a resilient partial ring shaped member, a rigid nipple storage enclosure, a necklace connection member, said resilient partial ring shaped member being approximately one and three quarters of an inch in diameter, said resilient partial ring shaped member having an approximate C shape where the gap in said C shape is approximately one quarter of an inch, said rigid nipple storage enclosure being approximately cylindrical in shape and having a closed top and an open bottom, said rigid nipple storage enclosure being fixedly and centrally attached from its top surface to the the inside surface of said resilient partial ring, said attachment point occurring at the inside surface of said resilient partial ring shaped member at a location opposite to said gap in said C shape, said necklace connection member including a necklace receiving aperture, and said necklace connection member fixedly attached to to outside surface of said resilient partial ring at a location directly above said nipple storage enclosure connection point.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a front view of the invention.

FIG. 2 is a front view showing the resilient nature of the invention.

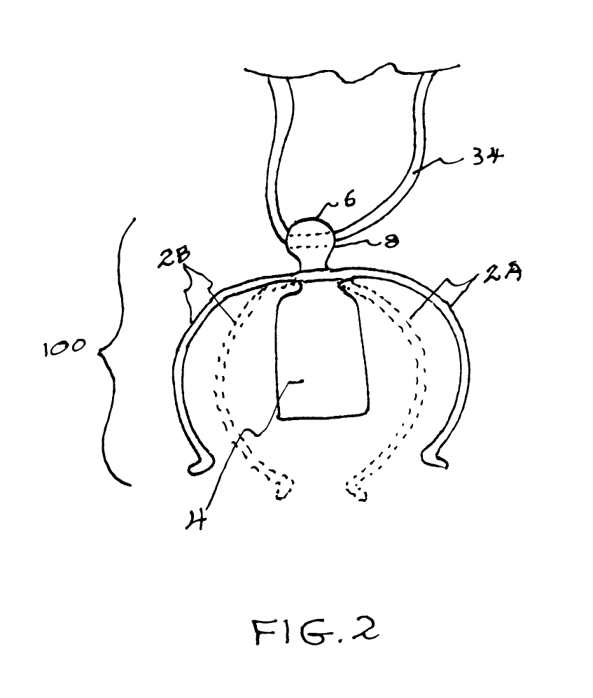

FIG. 3 is a side view of the invention.

FIG. 4 is a bottom view of the invention.

FIG. 5 is a perspective view of the invention holding a first pacifier.

FIG. 6 is a perspective view of the invention holding a second pacifier.

FIG. 7 is a perspective view of the invention holding a third pacifier.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

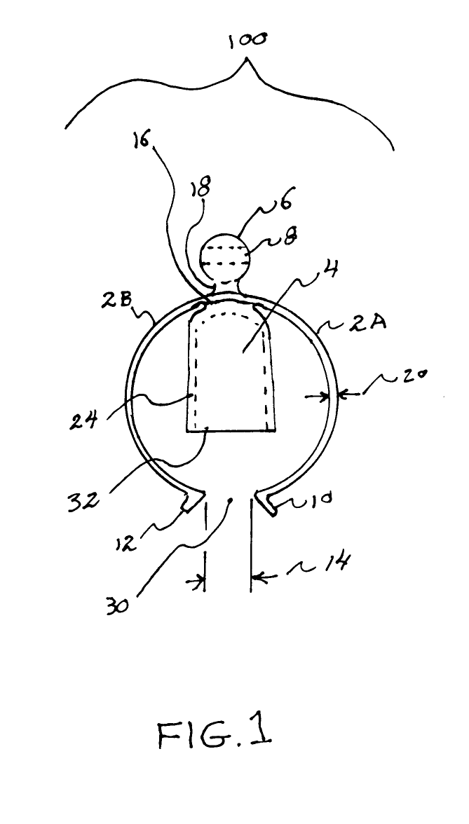

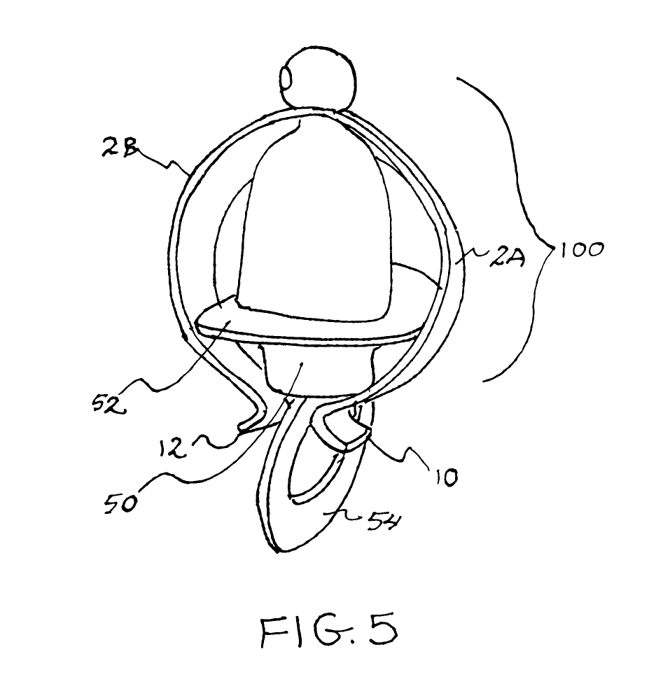

Referring now to FIG. 1 we see a front view of the invention 100. The invention 100 is designed to removably retain a standard pacifier as shown in FIGS. 5, 6 and 7. The C shaped resilient partial ring, comprised of right side 2A and left side 2B, is approximately one and three quarters of an inch in diameter. The gap 30 at the bottom of the ring is approximately one quarter of an inch as shown by dimension line 14. A nipple retaining enclosure 4 is approximately cylindrical and is made of thin walled rigid plastic as shown by dotted line 24. The nipple retaining enclosure 4 is closed at the top end and open at the bottom end. The nipple retaining enclosure 4 attached at its top end to the underside of partial ring 2A, 2B at location 16. A necklace retaining member 6 is attached to the top of partial ring 2A, 2B at location 18. An aperture 8, shown by dotted lines, allows a necklace or rope-like retaining device to be attached to the invention 100. In this way, a person can wear the invention 100 so that it, and the pacifier that it may be holding, is readily available to a parent or care giver. The wall thickness of the partial ring 2A, 2B as shown by dimension line 20 is approximately one sixteenth of an inch. A pair of tabs 10, 12 extend outward from at the gap area 30 at an approximately forty-five degree angle.

Figure two is a front view of the invention 100 which shows the resilience of the partial ring C shaped member where each side of the member 2A, 2B can be flexed from the location shown by the dotted lines, to the location shown by the undotted lines. This allows for the inclusion or removal of virtually any size of standard pacifier on the market today. The preferred material for the partial ring 2A, 2B is injection molded polycarbonate which is known for its springy, resilient nature. Nylon six would also make an ideal material for the partial ring 2A, 2B do to its ability to always return to its original shape after being flexed. A portion of a necklace 24 can be seen as it is installed through aperture 8 of necklace retaining member 6. A wrist band or key chain band can also be substituted for necklace 24.

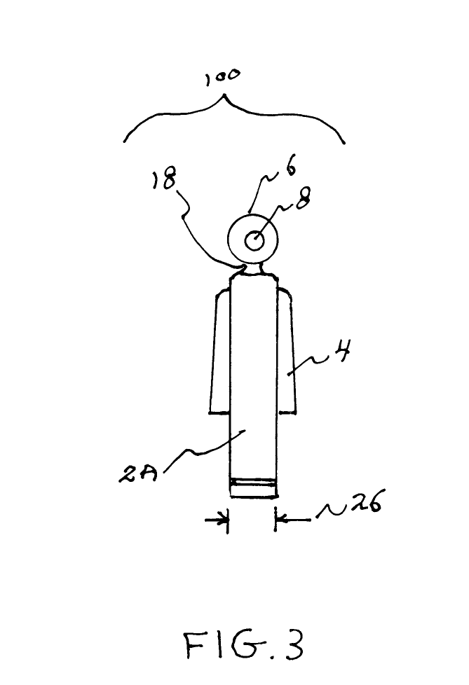

FIG. 3 shows a side view of the invention 100. The width of each leg 2A, 2B of the partial ring is approximately one half of an inch as shown by dimension line 26.

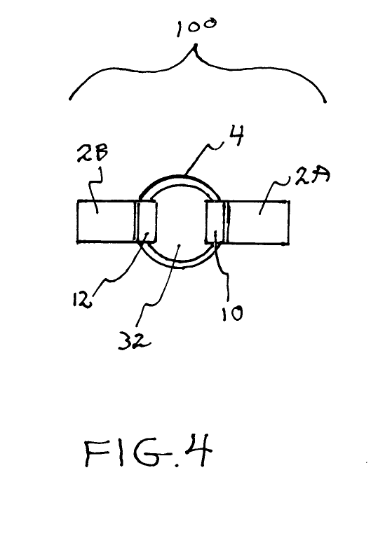

The bottom view shown in FIG. 4 shows the open bottom 32 of the nipple retaining portion 4. The inside diameter of the nipple retaining portion is approximately seven eighths of an inch.

FIG. 5 shows a perspective view of the invention 100 with a first version of a pacifier 50. The partial ring portions 2A, 2B are in intimate contact with the perimeter of the mouth guard 52 of the pacifier and the spring nature of the legs 2A, 2B hold the pacifier in place until a parent or care giver decides to make use of the pacifier 50 at which time they pull on pacifier ring 54 to remove the pacifier 50. The parent or care giver can then spread the legs 2A, 2B of the partial ring to replace the pacifier in the holder 100. The tabs 12, 10 help guide the pacifier into the invention 100 during the insertion process.

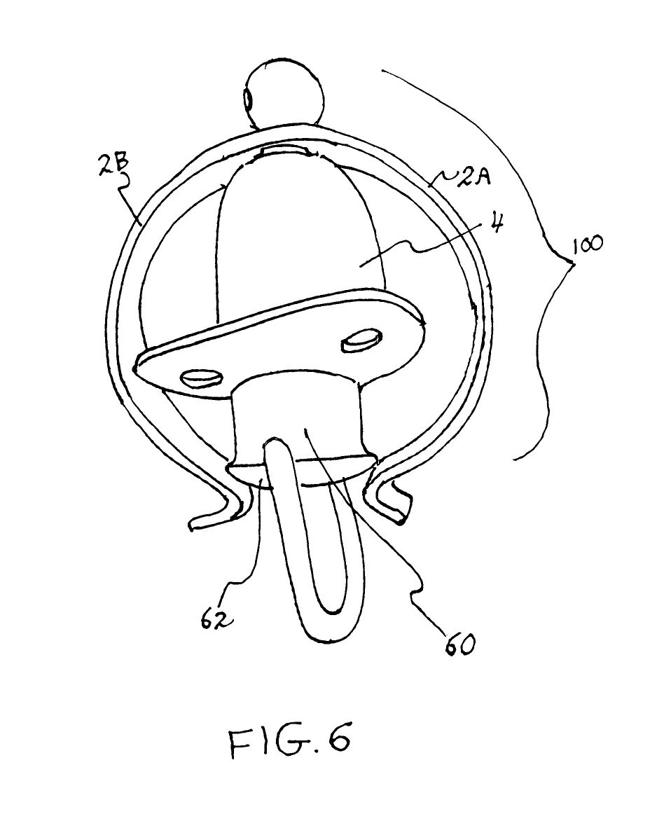

FIG. 6 shows a second pacifier 60 which is smaller than the first pacifier 50 and where the legs 2A, 2B are retaining tip of the central plastic assembly member of the pacifier 60.

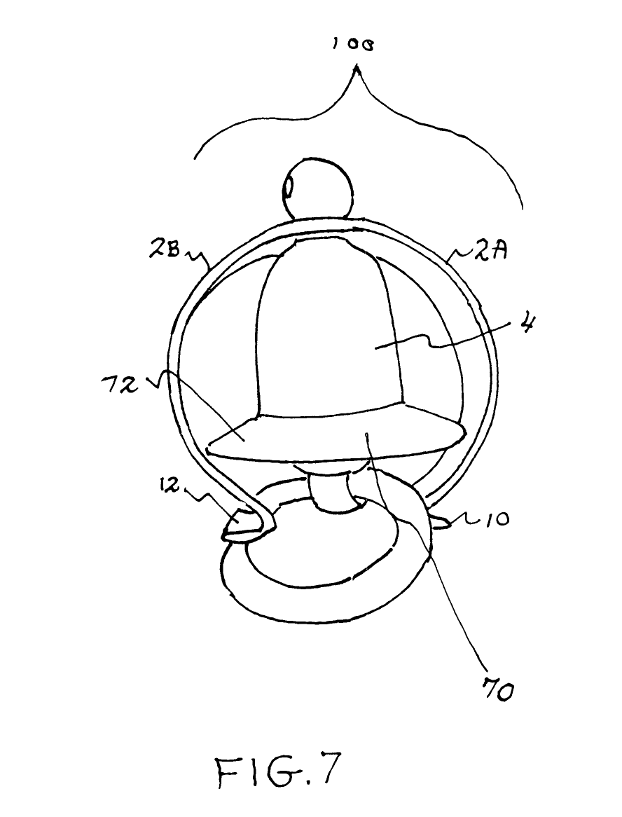

FIG. 7 shows a third pacifier 70 which has a mouth guard 72 with a round perimeter. Notice the width of tab ends 12, 10 showing the flexibility of the partial ring 2A, 2B and its ability to hold pacifiers of a wide variety of shapes and sizes.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. pacifier retaining device comprising:
a resilient partial ring shaped member;
a rigid nipple storage enclosure;
a necklace connection member;
said resilient partial ring shaped member being approximately one and three quarters of an inch in diameter;
said resilient partial ring shaped member having an approximate C shape where the gap in said C shape is approximately one quarter of an inch;
said rigid nipple storage enclosure being approximately cylindrical in shape and having a closed top and an open bottom;
said rigid nipple storage enclosure being fixedly and centrally attached from its top surface to the the inside surface of said resilient partial ring;
said attachment point occurring at the inside surface of said resilient partial ring shaped member at a location opposite to said gap in said C shape;
said necklace connection member including a necklace receiving aperture; and
said necklace connection member fixedly attached to to outside surface of said resilient partial ring at a location directly above said nipple storage enclosure connection point.

2. A pacifier retaining device as claimed in claim 1 wherein the end points of said C shaped partial ring shaped member include a fixedly attached lead in tab;
said lead in tabs formed at an approximately forty-five degree angle to said C shaped partial ring member.

3. A pacifier retaining device as claimed in claim 1 wherein said resilient partial ring shaped member is capable of being flexed by a user to allow the insertion or removal of a standard pacifier having a nipple and mouth guard.

4. A pacifier retaining device as claimed in claim 1 wherein said pacifier retaining device is injection molded from polycarbonate plastic material

5. A pacifier retaining device as claimed in claim 1 wherein the wall thickness of said C shaped resilient partial ring member is approximately one sixteenth of an inch thick and
the width of the side wall of is approximately one half of an inch.
